(19) United States
(12) Patent Application Publication
(10) Pub. No.: US 2026/0236355 A1
(43) Pub. Date: Aug. 13, 2026

(54) DATABASE DISASTER RECOVERY METHOD, DEVICE, SYSTEM, AND STORAGE MEDIUM

(71) Applicant: CLOUD INTELLIGENCE ASSETS HOLDING (SINGAPORE) PRIVATE LIMITED, Singapore (SG)

(72) Inventors: Jie ZHOU, Hangzhou, Zhejiang (CN); Jiawei XU, Hangzhou, Zhejiang (CN); Yingqiang ZHANG, Hangzhou, Zhejiang (CN); Guangqing DONG, Hangzhou, Zhejiang (CN)

(21) Appl. No.: 19/154,669

(22) PCT Filed: Apr. 2, 2024
(86) PCT No.: PCT/CN2024/085528

§ 371 Date: Aug. 7, 2025

(30) Foreign Application Priority Data
Apr. 4, 2023 (CN) 202310353850.9

(51) Int. Cl. G06F 11/16; G06F 11/20

(52) U.S. Cl. CPC G06F 11/1662; G06F 11/2033; G06F 2201/80

(57) ABSTRACT

Embodiments of the present application provide a database disaster recovery method, a device, a system, and a storage medium. In the embodiments of the present application, a primary node and a standby node are respectively registered as a holder and a registrant in a storage protocol. In this way, when the primary node is abnormal, the standby node may preempt a write permission of a cloud disk based on the storage protocol supported by the cloud disk, and switch to be the primary node, thereby implementing disaster recovery processing of a database based on support of the cloud disk.

### CROSS-REFERENCE TO RELATED APPLICATIONS

This application is a National Stage of International Application No. PCT/CN2024/085528, filed on Apr. 2, 2024, which claims priority to Chinese Patent Application No. 202310353850.9, filed with the China National Intellectual Property Administration on Apr. 4, 2023 and entitled “DATABASE DISASTER RECOVERY METHOD, DEVICE, SYSTEM, AND STORAGE MEDIUM”. These applications are incorporated herein by reference in their entireties.

### TECHNICAL FIELD The present application relates to the field of data storage technologies, and in particular, to a database disaster recovery method, a device, a system, and a storage medium.

### BACKGROUND

Most cloud native databases have a storage-compute separated architecture and consist of computing nodes and a shared distributed storage system. The computing nodes include one primary node and a plurality of read-only nodes. All the computing nodes share a same storage, and support one-write, multiple-read. That is, the primary node has a read-write permission on the distributed storage system, and the read-only nodes have read-only permissions on the distributed storage system. Such a solution has advantages such as flexible storage, high performance, and massive storage. However, because cloud native databases rely on a customized distributed storage system, the cloud native databases are expensive and are difficult to be delivered.

To overcome the two defects, in some solutions, a cloud disk supporting multi-attach is used to replace the distributed storage system. As a public cloud standard product, the cloud disk can save costs in terms of both costs and delivery difficulty. How to achieve a high availability capability consistent with that of an original database based on the cloud disk becomes a technical problem urgently to be resolved in the art.

### SUMMARY

Various aspects of the present application provide a database disaster recovery method, a device, a system, and a storage medium, to implement disaster recovery processing of a cloud disk-based database system, thereby helping ensure high availability of a database.

An embodiment of the present application provides a database disaster recovery method, where a database system includes: computing nodes and a cloud disk configured in a target mode; a holder in a storage protocol supported by the cloud disk has a read-write permission on the cloud disk in the target mode; a registrant in the storage protocol has a read-only permission on the cloud disk in the target mode; and the computing nodes include a primary node registered as the holder and a standby node registered as the registrant, and the method includes:
detecting, by the standby node, validity of lease information in a heartbeat file stored in the cloud disk, where the primary node in the database system maintains a primary node state by modifying the lease information;
in response to detecting that the lease information is invalid, preempting, by the standby node, a write permission of the cloud disk based on the storage protocol to register the standby node as a new holder; and
switching a node state of the standby node to the primary node state.

An embodiment of the present application further provides a database system, including a plurality of computing nodes and a cloud disk, where the plurality of computing nodes share the cloud disk; and the cloud disk is configured in a target mode, and stores a heartbeat file, where a holder in the storage protocol has a read-write permission on the cloud disk in the target mode; and a registrant in the storage protocol has a read-only permission on the cloud disk in the target mode; and
the computing device is configured to perform the steps in the foregoing database disaster recovery method.

An embodiment of the present application further provides a computing device, where the computing device is implemented as a computing node in a database system; the database system further includes a cloud disk configured in a target mode; a holder in a storage protocol supported by the cloud disk has a read-write permission on the cloud disk in the target mode; and a registrant in the storage protocol has a read-only permission on the cloud disk in the target mode; and
the computing device includes a memory and a processor, where the memory is configured to store a computer program; and the processor is coupled to the memory, and is configured to execute the computer program to perform the steps in the foregoing database disaster recovery method.

An embodiment of the present application further provides a computer-readable storage medium storing computer instructions, where the computer instructions, when executed by one or more processors, cause the one or more processors to perform the steps in the foregoing database disaster recovery method.

In embodiments of the present application, the primary node and the standby node are respectively registered as the holder and the registrant in the storage protocol. In this way, when the primary node is abnormal, the standby node may preempt the write permission of the cloud disk based on the storage protocol supported by the cloud disk, and switch to be the primary node, thereby implementing disaster recovery processing of the database based on support of the cloud disk. Because the storage protocol is the standard protocol supported by the cloud disk, the disaster recovery manner of the database provided in the embodiments, based on the standard storage protocol supported by the cloud disk, not only can implement disaster recovery processing on the database and ensure high availability of the cloud disk-based database, but also eliminates the need to additionally develop or customize a disaster recovery solution of another protocol for the cloud disk-based database and can improve universality of the disaster recovery processing solution of the cloud disk-based database.

### BRIEF DESCRIPTION OF DRAWINGS

The accompanying drawings described herein are used for providing a further understanding of the present application, and form part of the present application. Exemplary embodiments of the present application and descriptions thereof are used for explaining the present application, and do not constitute any inappropriate limitation to the present application. In the accompanying drawings:

FIG. 1 is a schematic structural diagram of a database system according to an embodiment of the present application;

FIG. 2 and FIG. 3 are schematic flowcharts of a database disaster recovery method according to an embodiment of the present application;

FIG. 4 is a schematic diagram of a process for determining a node state of a computing node according to an embodiment of the present application;

FIG. 5 is a schematic diagram of a startup process of a computing node according to an embodiment of the present application;

FIG. 6 is a schematic flowchart of another database disaster recovery method according to an embodiment of the present application; and

FIG. 7 is a schematic structural diagram of a computing device according to an embodiment of the present application.

### DESCRIPTION OF EMBODIMENTS

To state the objectives, technical solutions, and advantages of the present application more clearly, the technical solutions of the present application will be clearly and completely described below with reference to specific embodiments of the present application and the accompanying drawings. Apparently, the described embodiments are only some embodiments rather than all the embodiments of the present application. All other embodiments obtained by a person skilled in the art based on the embodiments of the present application without creative efforts shall fall within the protection scope of the present application.

To ensure high availability of a cloud disk-based database, in some embodiments of the present application, a primary node and a standby node are respectively registered as a holder and a registrant in a storage protocol. In this way, when the primary node is abnormal, the standby node may preempt a write permission of the cloud disk based on a storage protocol supported by the cloud disk, and switch to be the primary node, thereby implementing disaster recovery processing of the database based on support of the cloud disk. Because the storage protocol is the standard protocol supported by the cloud disk, the disaster recovery manner of the database provided in the embodiments, based on the standard storage protocol supported by the cloud disk, not only can implement disaster recovery processing on the database and ensure high availability of the cloud disk-based database, but also eliminates the need to additionally develop or customize a disaster recovery solution based on another protocol for the cloud disk-based database and can improve universality of a disaster recovery processing solution of the cloud disk-based database.

The following describes the technical solution provided in each embodiment of the present application in detail with reference to the accompanying drawings.

It should be noted that, the same reference numerals represent the same objects in the figures and embodiments below. Therefore, once an object is defined in a figure or embodiment, further discussion does not need to be performed on the object in subsequent figures and embodiments.

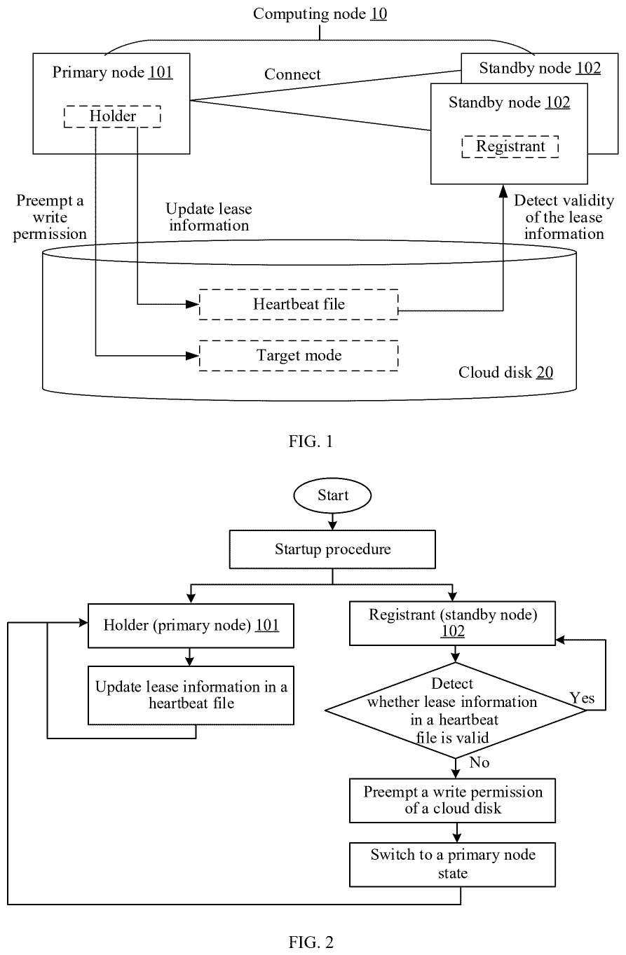

FIG. 1 is a schematic structural diagram of a database system according to an embodiment of the present application. As shown in FIG. 1, the database system includes a computing node 10 and a cloud disk 20. In this embodiment, a quantity of computing nodes 10 may be one or more. “More” refers to two or more than two. At least one cloud disk 20 may be attached to one computing node 10, and one cloud disk 20 may be used by one or more computing nodes 10. FIG. 1 only shows a plurality of computing nodes 10 and one cloud disk 20, but this is not limited thereto.

In this embodiment, the database system is a compute-storage separated system. The computing node 10 is an electronic device that performs a computing operation required by the database system. The computing operation required by the database system includes, but is not limited to, a query operation (such as aggregate query and join query), a data definition language (DDL) operation, and the like. The computing node 10 may be a single server device, or may be a cloudified server array, or may be a virtual machine (VM) running in a cloudified server array, or may be a cloud server (Elastic Compute Service, ECS). In addition, the computing node 10 may also refer to another computing device having a corresponding service capability, for example, a terminal device (running a service program) such as a computer.

The cloud disk 20 is a block storage device at a data block level that is provided by a cloud manufacturer for the cloud server, and is configured to implement a storage function of a database, and store data of the database. The cloud disk 20 may be implemented as a storage cluster including a plurality of magnetic disks. In this embodiment, the cloud disk 20 may support a multi-attach function. Multi-attach refers to attaching one cloud disk 20 to a plurality of computing nodes 10, so that the plurality of computing nodes 10 may perform concurrent read-write access to the same cloud disk 20. That is, the plurality of computing nodes 10 share the cloud disk 20. The cloud disk supporting multi-attach may also be referred to as a shared disk.

In this embodiment, the plurality of computing nodes 10 sharing the cloud disk 20 may be located in a same available area. Available areas refer to physical areas with mutually independent electric power and networks in a same region. Electric power and networks are isolated between different available areas.

Because the plurality of computing nodes 10 share the cloud disk 20, the plurality of computing nodes 10 may perform concurrent read-write access to the cloud disk 20. This may cause split-brain in the database system, and damage consistency of data in the database. To reduce a probability of generating split-brain in the database, the plurality of computing nodes 10 may determine a primary node 101 and a standby node 102 through leader election. The primary node has a read-write permission on the cloud disk 20, and the standby node has a read-only permission on the cloud disk 20.

During actual application, the primary node 101 may have an abnormality, causing the primary node to be in an unserviceable state. In this case, the database needs to have a disaster recovery capability to ensure a high availability capability of the database. The high availability capability of the database generally includes three parts: primary node abnormality detection, leader election, and primary node switchover. The primary node abnormality detection refers to the ability to detect that the primary node is in an unserviceable state as quickly as possible when the primary node is abnormal and to trigger a disaster recovery action. The leader election refers to the requirement to select a unique standby node from the plurality of standby nodes to promote to the primary node in a scenario of database disaster recovery with a plurality of standby nodes, and the decision requires consensus among all the computing nodes. The primary node switchover refers to switching a node state of the standby node to the primary node. A key to the primary node switchover is to ensure that “split-brain” does not occur in the database system. This requires that only after input/output fencing (IO Fencing) is performed on an original primary node can a new primary node start to provide a service, thereby implementing disaster recovery of the database.

The IO fencing refers to, for a system that shares storage in a one-write-multi-read mode, allowing only one node to perform writing at a same moment. In a scenario of disaster recovery and switchover, only after it is ensured that the original primary node stops writing, the new primary node can be allowed to provide the service. Otherwise, data damage will be caused due to “split-brain”. An action of prohibiting the original primary node from writing at a storage level is referred to as IO fencing.

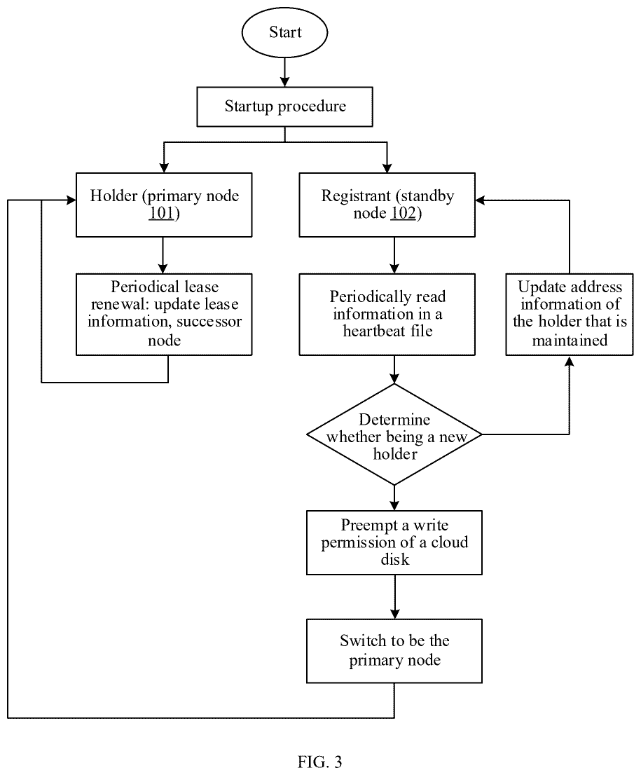

In this embodiment, to implement disaster recovery processing on a cloud disk-based database, a heartbeat file is set in the cloud disk 20. The heartbeat file may be used to perform heartbeat detection on the primary node, to determine whether the primary node 101 has an abnormality. Specifically, the heartbeat file may include lease information. With reference to FIG. 1, FIG. 2, and FIG. 3, the primary node 101 may maintain a primary node state by updating the lease information of the heartbeat file. That is, the primary node 101 implements renewal of the primary node state by updating the lease information of the heartbeat file. The primary node 101 may periodically update the lease information in the heartbeat file according to a set lease renewal cycle. The standby node 102 may determine, by detecting validity of the lease information in the heartbeat file (that is, the standby node 102 detects whether the lease information in the heartbeat file is valid), whether the primary node 101 is abnormal. The standby node 102 detects that the lease information in the heartbeat file is invalid, and determines that the primary node 101 is abnormal.

In some embodiments, the lease information may be timestamp information. The timestamp information is a moment corresponding to expiration of a lease. For example, if the timestamp information is Mar. 16, 2023, 9:38, the lease expiration moment is Mar. 16, 2023, 9:38. The primary node 101 may maintain the primary node state by updating the lease information in the heartbeat file. Specifically, the primary node 101 may update, according to a set lease update cycle, the lease information in the heartbeat file before a timestamp of the lease information recorded in the heartbeat file arrives. For example, before the timestamp of the lease information recorded in the heartbeat file arrives, the timestamp of the lease information recorded in the heartbeat file may be updated to: the time when the lease information is updated plus a validity duration. For example, if the validity duration of the lease is five minutes, and the timestamp of the lease information recorded in the heartbeat file is Mar. 16, 2023, 9:00, the primary node 101 may update, before Mar. 16, 2023, 9:00 arrives (for example, Mar. 16, 2023, 8:59), the timestamp of the lease information recorded in the heartbeat file to: the time when the lease information is updated plus the validity duration. For example, the lease information recorded in the heartbeat file is updated to Mar. 16, 2023, 9:04 at Mar. 16, 2023, 8:59. In the foregoing embodiment, only an example in which the lease update period and the validity duration of the lease are in the order of minutes is used for exemplary description. In an actual use process, the lease update period and the validity duration of the lease may be in the order of seconds.

Correspondingly, the standby node 102 may periodically read the lease information in the heartbeat file according to the set data reading cycle (corresponding to “periodically reading the information in the heartbeat file” in FIG. 3); and determine that the lease information in the heartbeat file is invalid if the timestamp of the lease information is earlier than the current time. The data reading cycle is shorter than the validity duration of the lease information in the heartbeat file. The cloud disk 20 supports a corresponding storage protocol standard. For example, the cloud disk 20 may support a non-volatile memory host controller interface specification (Non-Volatile Memory Express, NVMe) protocol, an advanced host controller interface (APCI) protocol, or a small computer system interface (SCSI) protocol. The storage protocol defines a permission of a cloud disk and a permission of a client.

Usually, there are different role types in the storage protocol. Different roles have different access permissions on the cloud disk. Roles in the storage protocol usually include different roles such as a holder, a registrant, and a non-registrant (visitor). The holder has all operation permissions on the cloud disk, the registrant has partial operation permissions on the cloud disk, and the visitor has only a read permission on the cloud disk.

The multi-attach cloud disk has different modes, and different roles in the storage protocol have different access permissions for cloud disks in different modes. For a cloud disk in a target mode, the holder in the storage protocol has the read-write permission on the cloud disk, and the registrant or the visitor has the read-only permission. For example, for a persistent reservation (PR) protocol in the storage protocol (such as the NVMe protocol), when the cloud disk supporting multi-attach is in a write exclusive mode, the holder in the PR protocol has the read-write permission on the cloud disk, and the registrant or the visitor has the read-only permission. Correspondingly, in the PR protocol, the target mode is the write exclusive mode.

Because the cloud disk is in the target mode, the holder in the storage protocol has the read-write permission on the cloud disk, which is the same as a function of the primary node. The registrant has the read-only permission, which is the same as a function of the standby node. Therefore, in this embodiment of the present application, IO permission management of the cloud disk may be performed for the computing node 10 based on the storage protocol supported by the cloud disk.

Specifically, when the cloud disk 20 is attached to the computing node 10, a mode of the cloud disk 20 may be configured as the target mode. In this way, the holder in the storage protocol has the read-write permission on the cloud disk, and the registrant or the visitor has the read-only permission. The configuration process may be preset by operation and maintenance personnel of the database. Certainly, the mode of the cloud disk 20 may be configured as the target mode by the primary node 10 in the computing nodes 10 via an interface of the storage protocol in a successful leader election process.

In this embodiment, the cloud disk is configured in the target mode. During startup, the computing node 10 may determine a node state of the computing node 10. In this embodiment of the present application, a specific implementation of the computing node 10 determining the node state of the computing node 10 is not limited.

In some embodiments, the computing node 10 may detect whether the heartbeat file exists in the cloud disk 20. If the heartbeat file does not exist in the cloud disk 20, it indicates that the database system is a new instance, and there is no primary node, and the computing node 10 may determine that the node state of the computing node 10 is the primary node. If the heartbeat file exists in the cloud disk, and the identifier of the cloud disk recorded in the heartbeat file is different from the identifier of the cloud disk maintained by the computing node 10, it indicates that the database system is an instance of cloud disk recovery, that is, the cloud disk attached to the computing node 10 is a new cloud disk snapshot, and it may be determined that the node state of the computing node 10 is the primary node. That is, it is determined that the computing node 10 is the primary node if the heartbeat file does not exist in the cloud disk 20 or the identifier of the cloud disk recorded in the heartbeat file is different from the identifier of the cloud disk maintained by the computing node 10. In some embodiments, if the heartbeat file exists in the cloud disk, and identification information of the cloud disk recorded in the heartbeat file is the same as the identifier of the cloud disk maintained by the computing node, it is determined that the state of the computing node 10 is the standby node.

In some other embodiments, to prevent, when the primary node is abnormal, a Ping-Pong livelock generated when the standby nodes perform leader election concurrently, a unique successor node mechanism is proposed. The Ping-Pong livelock means that when the primary node is abnormal, and when a plurality of standby nodes concurrently perform leader election, a standby node has not written address information of the standby node into the heartbeat file after successfully updating the lease information in the heartbeat file, and the lease information in the heartbeat file has been updated by another standby node, causing a phenomenon of livelock.

To reduce a probability of generating a Ping-Pong livelock when the standby nodes perform leader election concurrently when the primary node is abnormal, the primary node 101 may designate a successor node from the standby nodes to take over the primary node's write access to the cloud disk when the primary node is abnormal. A specific implementation of the primary node 101 designating the successor node is described in the following embodiment, and is not detailed here. Based on an embodiment in which the primary node 101 designates the successor node, the node state of the computing node may be further determined with reference to information about the successor node. The information about the successor node may be an identifier of the successor node, and the primary node 101 may write the identifier of the successor node into the heartbeat file.

Correspondingly, it is determined that the node state of the computing node 10 is the standby node if the heartbeat file exists in the cloud disk, the identification information of the cloud disk recorded in the heartbeat file is the same as the identifier of the cloud disk maintained by the computing node, and the computing node 10 is not the successor node. The successor node refers to a standby node that is designated by the primary node to take over the primary node's write access to the cloud disk when the primary node is abnormal. Detailed descriptions regarding the successor node are provided in the following embodiments and are not repeated here.

Further, it is determined that the node state of the computing node 10 is the primary node if the heartbeat file exists in the cloud disk, the identification information of the cloud disk recorded in the heartbeat file is the same as the identifier of the cloud disk maintained by the computing node, the computing node 10 is the successor node, and the lease information recorded in the heartbeat file is invalid.

Correspondingly, it is determined that the node state of the computing node 10 is the standby node if the heartbeat file exists in the cloud disk, the identification information of the cloud disk recorded in the heartbeat file is the same as the identifier of the cloud disk maintained by the computing node, the computing node 10 is the successor node, and the lease information recorded in the heartbeat file is within a validity period.

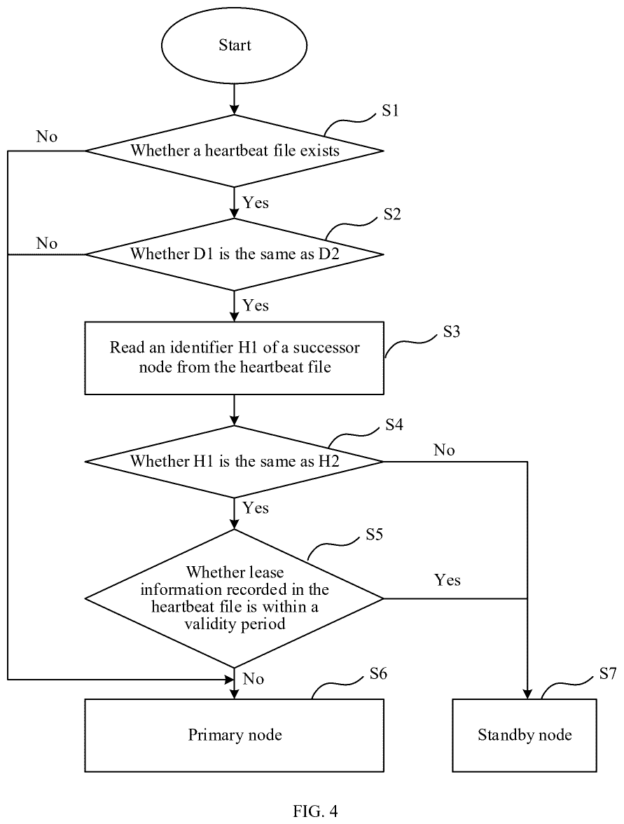

In this embodiment, a specific execution sequence of the foregoing steps of determining the node state is not limited. In some embodiments, the node state of the computing node may be determined in a node state detection manner shown in FIG. 4. As shown in FIG. 4, the node state detection method of the computing node mainly includes the following steps.
S1: Detect whether a heartbeat file exists; and if yes, perform step S2; or if not, perform step S6.
S2: Detect whether an identifier D1 of a cloud disk recorded in the heartbeat file is the same as an identifier D2 of a cloud disk maintained by the computing node; and if yes, perform step S3; or if not, perform step S6.
S3: Read an identifier H1 of a successor node from the heartbeat file.
S4: Determine whether the identifier H1 of the successor node recorded in the heartbeat file is the same as an identifier H2 of the successor node maintained by the computing node; and if yes, perform step S5; or if not, perform step S7.
S5: Detect whether lease information recorded in the heartbeat file is within a validity period; and if yes, perform step S7; or if not, perform step S6.
S6: Determine that the node state of the computing node is a primary node.
S7: Determine that the node state of the computing node is a standby node.

A manner of determining the node state of the computing node shown in the foregoing embodiment is merely exemplary descriptions, but does not constitute a limitation. Further, if the node state of the computing node 10 is the primary node, it is determined that the primary node is a holder in a storage protocol, and the computing node 10 may be registered as the holder in the storage protocol. If the node state of the computing node 10 is the standby node, the standby node is a registrant in the storage protocol, and the computing node 10 may be registered as the registrant in the storage protocol. In this way, the computing node 10 may perform, based on the storage protocol supported by the cloud disk, disaster recovery processing on a cloud disk-based database. This part of content is described in the following embodiments, and details are not described here.

The primary node 101 may preempt a write permission of the cloud disk 20 based on the storage protocol supported by the cloud disk, to register the primary node 101 as the holder in the storage protocol. Specifically, for an embodiment in which the storage protocol is an NVMe protocol, the primary node 101 may invoke a priority preempt (Preempt Action) interface provided by a PR protocol in the NVMe protocol, and obtain the write permission of the cloud disk via the priority preempt interface, to register the primary node 101 as a holder in the PR protocol.

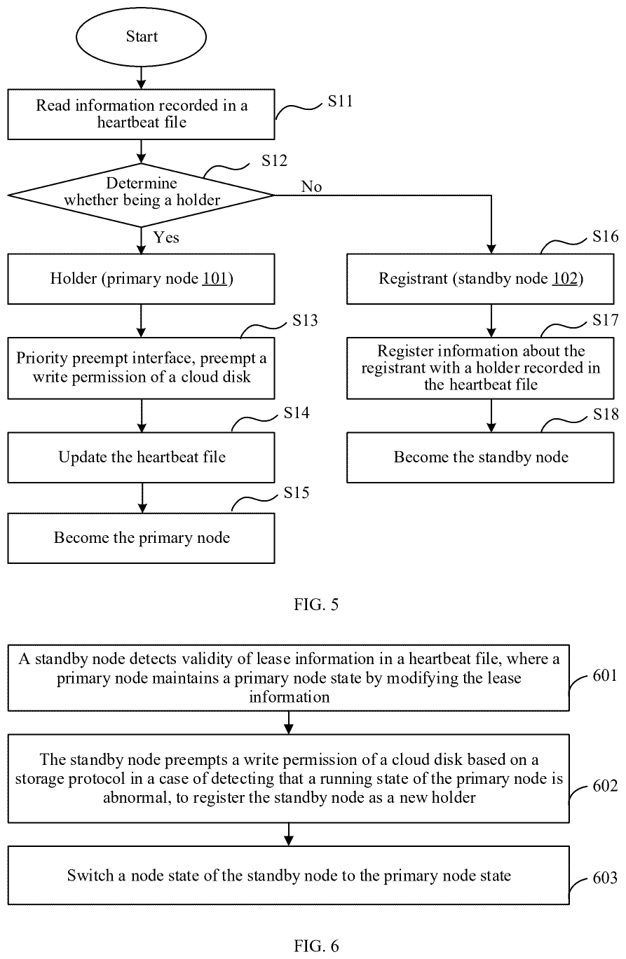

Optionally, the computing node 10 may invoke a register interface of the PR protocol, to register the computing node 10 as a registrant in the PR protocol. Further, the computing node 10 may determine the node state of the computing node 10. For the specific implementation of determining the node state of the computing node, reference can be made to the related content of the foregoing embodiment, and details are not described herein. A “startup procedure” in FIG. 2 and FIG. 3 may be implemented as FIG. 5. Step S11 and step S12 in FIG. 5 correspond to the related content of the computing node determining the node state of the computing node. For example, step S11 and step 12 may be implemented as in FIG. 4. The information recorded in the heartbeat file read in step S11 may include: the identifier of the cloud disk recorded in the heartbeat file, the identifier of the successor node recorded in the heartbeat file, the lease information recorded in the heartbeat file, and the like.

Further, if the node state of the computing node is the primary node, it is determined that the computing node is the holder in the storage protocol. Correspondingly, as shown in step S13 in FIG. 5, the primary node registered as the holder may invoke the priority preempt interface provided by the PR protocol in the NVMe protocol, and preempts the write permission of the cloud disk via the priority preempt interface, to modify a role type of the computing node from the registrant to the holder. As shown in step S14 and step S15 in FIG. 5, the primary node registered as the holder may further update the heartbeat file to become the primary node of the database system. The updating the heartbeat file in FIG. 5 includes but is not limited to: updating the lease information in the heartbeat file, updating address information of the holder that is recorded in the heartbeat file, and the like. Correspondingly, if the node state of the computing node is the standby node, the computing node continues to be maintained as the registrant (corresponding to step S16 in FIG. 5). Certainly, the primary node registered as the holder may further configure the cloud disk as the target mode via the priority preempt interface.

With reference to FIG. 1, FIG. 2, and FIG. 3, the primary node 101 in the database system may maintain the primary node state by updating the lease information in the heartbeat file. That is, the primary node 101 implements renewal of the primary node state by updating the lease information in the heartbeat file. The standby node 102 may determine, by detecting validity of the lease information in the heartbeat file, whether the primary node 101 is abnormal. For a specific implementation of detecting, by the standby node 102, the validity of the lease information recorded in the heartbeat file, reference can be made to the related content in the foregoing embodiments.

The standby node 102 may preempt the write permission of the cloud disk based on the storage protocol in the case of detecting that the lease information recorded in the heartbeat file is invalid, to register the standby node as a new holder (corresponding to “preempting the write permission of the cloud disk” in FIG. 2 and FIG. 3). For a specific implementation of the successor node preempting the write permission of the cloud disk based on the storage protocol, reference can be made to the related content of preempting, by the primary node 101, the write permission of the cloud disk based on the storage protocol, and details are not described here. Further, the standby node may switch a node state of the standby node to the primary node state. That is, the standby node becomes a new primary node, and is responsible for reading and writing the cloud disk 20. Other standby node continues to remain as a registrant in the storage protocol, and has the read-only permissions on the cloud disk 20.

The new primary node may update the information recorded in the heartbeat file. For example, the new primary node may update the lease information in the heartbeat file, and update address information of the holder that is recorded in the heartbeat file to address information of the new primary node.

In this embodiment, the primary node and the standby node are respectively registered as the holder and the registrant in the storage protocol. In this way, when the lease of the primary node is invalid, the standby node may preempt the write permission of the cloud disk based on the storage protocol supported by the cloud disk, and switch to be the primary node, thereby implementing disaster recovery processing on the database based on support of the cloud disk. Because the storage protocol is the standard protocol supported by the cloud disk, the disaster recovery manner of the database provided in this embodiment, based on the standard storage protocol supported by the cloud disk, implements disaster recovery processing on the database, there is no need to additionally develop or customize a disaster recovery solution of another protocol for the cloud disk-based database, and universality of the disaster recovery processing solution of the cloud disk-based database can be improved.

In addition, because the standby node preempts the write permission on the cloud disk when the lease of the primary node is invalid, and registers as the new holder, the original primary node loses the write permission of the cloud disk. Even if the original primary node is restarted, the original primary node cannot write data into the cloud disk because the write permission of the cloud disk is lost. Therefore, IO fencing against the original primary node is achieved, and a probability of database split-brain may be reduced.

In this embodiment of the present application, to reduce a probability of generating a ping-pong livelock when the standby nodes perform leader election concurrently when the primary node is abnormal, the primary node 101 may determine a successor node from the standby nodes registered as the registrants in the storage protocol.

In this embodiment of the present application, a specific implementation of the primary node 101 determining the successor node from the standby nodes is not limited. In some embodiments, the primary node 101 may randomly select one standby node from the plurality of standby nodes 102 as the successor node.

In some other embodiments, the primary node 101 may select one standby node from the plurality of standby nodes 102 as the successor node based on a priority mechanism. Specifically, the primary node 101 may obtain priorities of the plurality of standby nodes; and select, according to the priorities of the plurality of standby nodes, a standby node having a highest priority as the successor node.

Optionally, the primary node 101 may obtain performance parameter information of the plurality of standby nodes 102. A performance parameter of the standby node refers to a parameter reflecting performance quality of the standby node, and may include information such as a playback delay of the standby node, a network delay, and a resource specification of the standby node. The playback delay of the standby node refers to delay time from the primary node holding an access operation on the cloud disk to the standby node playing back the record. The resource specification of the standby node is used to reflect a resource size of the standby node. Resources of the standby node mainly include, but are not limited to, a computing resource (such as a quantity of cores of a central processing unit (CPU)), a memory resource, and the like.

Specifically, with reference to FIG. 5, after being determined as the standby node, the computing node may be registered as the registrant in the storage protocol. Further, as shown in step S17 and step S18 in FIG. 5, the computing node determined as the standby node is registered as the registrant, and may register information about the registrant (namely, the standby node) with the holder recorded in the heartbeat file, and the computing node becomes the standby node in the database system. Specifically, the computing node determined as the standby node reads address information of the holder from the heartbeat file, and registers its own information with the holder (namely, the primary node) based on the address information of the holder. In this embodiment, the computing node determined as the standby node may send, based on the address information of the holder, the performance parameter information of the standby node to the primary node corresponding to the holder. The primary node may receive the performance parameter information sent by the standby node.

The primary node 101 may determine the priorities of the plurality of standby nodes 102 according to the performance parameter information of the plurality of standby nodes 102. A standby node having performance parameter information reflecting better performance has a higher priority. For example, for the playback delay and the network delay of the standby node, shorter delay time indicates better performance of the standby node. For the resource specification of the standby node, a larger resource specification indicates better performance of the standby node.

Optionally, the primary node 101 may calculate priority scores of the standby nodes 102 according to preset weights of various preset performance parameter information and the performance parameter information of the standby nodes 102; and determine priorities of the standby nodes 102 according to the priority scores of the plurality of standby nodes 102. A standby node having a higher priority score has a higher priority.

Alternatively, in some other embodiments, the computing node 10 may provide a priority setting interface. A user may specify the priorities of the plurality of standby nodes 102 via the priority setting interface. Optionally, when determining that the computing node 10 itself is the primary node, the computing node 10 may send prompt information to a terminal device of the user, to prompt the user to manually set the priorities of the standby nodes. The user may invoke the priority setting interface through the terminal device, and configure the priorities of the plurality of standby nodes via the priority setting interface. Optionally, the priority setting interface may be a structured query language (SQL) interface. Correspondingly, the user may invoke the interface through SQL, and configure the priorities of the standby nodes through the SQL. The computing node 10 serving as the primary node may obtain the priorities of the plurality of standby nodes 102 specified via the priority setting interface.

Further, after obtaining the priorities of the plurality of standby nodes 102, the primary node 101 may select, according to the priorities of the plurality of standby nodes 102, a standby node having a highest priority as the successor node.

The method of determining the successor node shown in the foregoing embodiments is merely exemplary descriptions, and does not constitute a limitation. The primary node 101 may further write the identifier of the successor node into the heartbeat file. Specifically, the primary node 101 may write the identifier of the successor node into a successor node information field in the heartbeat file. The identifier of the successor node refers to information uniquely identifying a computing node, which may be a unique number (Identity Document, ID) of the computing node, or may be the address information of the computing node. The address information of the computing node may be an Internet protocol (IP) address and the like.

The standby node 102 may detect validity of the lease information recorded in the heartbeat file in the cloud disk 20, and enter a leader election procedure when detecting that the lease information recorded in the heartbeat file is invalid. Specifically, the standby node 102 may obtain the identifier of the successor node from the heartbeat file. If the identifier of the successor node recorded in the heartbeat file is the standby node 102's own identifier, the standby node 102 determines that the standby node 102 itself is the successor node designated by the primary node 101 (corresponding to “detecting whether the standby node is a new holder” in FIG. 3). Here, being determined as the successor node means being determined as the new holder. The successor node may perform a leader election operation. If the identifier of the successor node recorded in the heartbeat file is not the standby node 102's own identifier, the standby node 102 determines that the standby node itself is not the successor node, and does not perform the leader election operation.

The foregoing unique successor node mechanism can ensure that only the successor node designated by the primary node can become a new primary node, which can effectively avoid leader election being performed by the plurality of standby nodes concurrently when the primary node is abnormal, and thus reduce the probability of generating a Ping-Pong livelock.

As shown in FIG. 3, the successor node may preempt the write permission on the cloud disk based on the storage protocol in the case of detecting that the lease information recorded in the heartbeat file is invalid, to register the successor node as the new holder. Further, the successor node may switch the node state of the successor node to the primary node state. That is, the successor node becomes a new primary node, and is responsible for reading and writing the cloud disk 20. Other standby nodes continue to remain as registrants in the storage protocol, and have the read-only permissions on the cloud disk 20. In this way, only the successor node performs leader election, which can effectively prevent the plurality of standby nodes from performing leader election concurrently when the primary node is abnormal, and thereby reduce the probability of generating a Ping-Pong livelock.

In this embodiment of the present application, after preempting the write permission on the cloud disk, the successor node updates the information recorded in the heartbeat file. For example, the successor node may update the lease information recorded in the heartbeat file, update the address information of the holder that is recorded in the heartbeat file to address information of the successor node, and certainly, may also update epoch information (epoch) in the heartbeat file. Other standby nodes may obtain the address information of the new holder from the heartbeat file, and update the maintained address information of the holder to the address information of the new holder (namely, the successor node) (corresponding to “updating the maintained address information of the holder” in FIG. 3).

The term information (epoch) may be an increasing field, that is, each time the term information is updated, a corresponding value increases by a set gradient. For example, for each update, the term information increases by 1 and so on.

By studying and analyzing a generation (Generation) field in the storage protocol, the inventors of the present application found that, according to the storage protocol standard, the Generation field increases in the following three cases: (1) registration or deregistration of a registrant in the storage protocol causes the Generation field to increase; (2) a release-clear action of the storage protocol may cause the Generation field to increase; and (3) a preempt or priority preempt (acquire/preempt) action corresponding to the storage protocol triggers the Generation to increase.

Because the Generation field automatically increases, the Generation field in the storage protocol may be used as the term information. The present application does not relate to increase of the Generation field caused by the foregoing case (2). Therefore, the foregoing case (2) does not fall within the discussion scope of the present application.

In this embodiment, the successor node may update the term information in the heartbeat file after preempting the write permission of the cloud disk. Because the successor node preempting the write permission of the cloud disk belongs to the foregoing case (3), the Generation field is used as the term information in the heartbeat file, and the operation of the successor node to preempt the write permission of the cloud disk triggers the Generation field to automatically increase.

The successor node may further modify the address information of the holder recorded in the heartbeat file into the address information of the successor node. The standby node 102 may monitor the term information in the heartbeat file; and obtain first address information of the holder from the heartbeat file in the case of detecting that the term information recorded in the heartbeat file changes. If first address information of the holder that is recorded in the heartbeat file is different from second address information of the holder that is maintained by the standby node, the standby node 102 establishes, based on the first address information of the holder that is recorded in the heartbeat file, a connection to the primary node corresponding to the first address information. If the first address information of the holder that is recorded in the heartbeat file is the same as the second address information of the holder that is maintained by the standby node, it indicates that the term information changes due to other cases, and the standby node 102 continues to maintain a connection to the primary node corresponding to the second address information. For example, for the foregoing Generation field, the foregoing case (1) and case (2) also cause the Generation field to increase, but do not cause update of the address information of the holder that is recorded in the heartbeat file.

During actual application, after recovering from an abnormality, the original primary node may be shut down or restarted. In the case of the primary node being restarted, the original primary node reads the identifier of the successor node from the heartbeat file after being restarted. If the original primary node determines that the successor node is not the original primary node, the original primary node automatically adjusts the node state to the standby node state.

During actual application, some expected restarts of the primary node do not require triggering disaster recovery switching, which can maintain the stability of computing node roles. For a set shutdown instruction (such as a Shutdown instruction), the original primary node may modify the identifier of the successor node in the heartbeat file into the identifier of the original primary node in response to the set shutdown instruction. In this way, in a subsequent restart process of the original primary node in response to the shutdown instruction, even if the lease information recorded in the heartbeat file expires, the original primary node can continue to maintain the primary node state, thereby helping keep role stability of the computing node.

In some other embodiments, there may be a case where the successor node is not available. Because atomicity of the three operations of the leader election operation cannot be guaranteed, where the three operations include (a) determining that the lease information recorded in the heartbeat file is invalid, (b) updating the lease information in the heartbeat file, and (c) performing a priority preempt operation to obtain the write permission on the cloud disk, etc., the unique successor mechanism is used in some of the foregoing embodiments to avoid concurrent leader election.

However, this implementation has the following defect: if the successor node recorded in the heartbeat file is unavailable, and the original primary node fails to find that the successor node is unavailable in advance, there will be no computing node performing leader election, rendering the cloud disk 20 permanently unavailable. Based on this, a successor node invalidity mechanism is introduced. Specifically, the standby node 102 may sleep for a random duration in a case of detecting that the lease information recorded in the heartbeat file is invalid and that the successor node is abnormal; and preempt, after sleeping for the random duration, the write permission of the cloud disk based on the storage protocol.

Specifically, the standby node 102 may monitor, in the case of detecting that the lease information in the heartbeat file is invalid, whether the lease information in the heartbeat file is updated; and if the lease information in the heartbeat file remains un-updated beyond a set duration, determine that the successor node is abnormal. The duration in which the lease information in the heartbeat file is un-updated may be timed from when the standby node detects that the lease information in the heartbeat file is invalid. The set duration may be flexibly set according to an actual efficiency requirement of disaster recovery. For example, the set duration may be three minutes, five minutes, or the like.

In the foregoing embodiment, the duration for which the standby node sleeps is random, and may be timed from when it is determined that the successor node is abnormal. For example, if the set duration is three minutes, and the time when the standby node detects that the lease information in the heartbeat file is invalid is at 10:00, the standby node may start to sleep for the random duration from 10:03. Because the durations in which respective standby nodes sleep are random, randomness is introduced. In the process in which each standby node randomly sleeps, there may be two standby nodes whose random durations of sleep have a difference value exceeding a total execution duration of the foregoing three operations (a), (b), and (c). In this case, there will be one of the standby nodes succeeding in leader election. For example, it is assumed that the total execution duration of the three operations (a), (b), and (c) is 30 seconds, a standby node A sleeps for two minutes, and a standby node B sleeps for three minutes. In this way, while the standby node B is still in a sleeping process, the standby node A performs a leader election operation after sleeping for two minutes, which takes about 30 seconds, and the standby node A succeeds in leader election in the sleeping process of the standby node B. In this embodiment, for a scenario in which there is no primary node for a long time, the database system is finally available at the cost of time and a small probability of Ping Pong, thereby helping improve robustness of the database.

In the foregoing embodiments, the database disaster recovery manner provided in the embodiments of the present application is illustratively described only with the case of a plurality of computing nodes. Certainly, the database disaster recovery manner provided in the embodiments of the present application may also be compatible with a database system without a standby node. In such a database system, the primary node may use itself as the successor node, and write the primary node's own identifier into the successor node field in the heartbeat file. In this way, in a restart process, the primary node detects that the successor node recorded in the heartbeat file is the primary node itself, and then, can preempt the write permission of the cloud disk again based on the storage protocol and become the holder.

During actual application, the standby node may also encounter an abnormality, stop running, or other cases, resulting in disconnection of a connection link with the primary node. In a case of detecting that a standby node exits from the registrant, the primary node may delete relevant information of the standby node and the like when selecting the successor node.

In addition to the foregoing database system, an embodiment of the present application further provides a database disaster recovery method. The database disaster recovery method provided in the embodiment of the present application is exemplarily described below.

FIG. 6 is a schematic flowchart of a database disaster recovery method according to an embodiment of the present application. The method is applicable to a computing node in a database system. The database system further includes a cloud disk configured in a target mode. The cloud disk stores a heartbeat file. A holder in a storage protocol has a read-write permission on the cloud disk in the target mode. A registrant in the storage protocol has a read-only permission on the cloud disk in the target mode. Based on this, a primary node in the database system may be registered as the holder in the storage protocol, and a standby node in the database system may be registered as the registrant in the storage protocol. The primary node registered as the holder may maintain a primary node state by modifying lease information in the heartbeat file.

In this embodiment, the computing node may be the standby node of the database at a moment, and may also be implemented as the primary node of the database at another moment. Therefore, in the database disaster recovery method provided in the embodiment of the present application, an execution logic of the primary node and an execution logic of the standby node may be implemented on the same computing node.

Based on the foregoing storage protocol, as shown in FIG. 6, the database disaster recovery method provided in the embodiment of the present application may include the following steps.

601: A standby node detects validity of lease information in a heartbeat file, where a primary node maintains a primary node state by modifying the lease information.

602: The standby node preempts a write permission of a cloud disk based on a storage protocol in a case of detecting that a running state of the primary node is abnormal, to register the standby node as a new holder.

603: Switch a node state of the standby node to the primary node state.

The database disaster recovery method shown in FIG. 6 is mainly applicable to a standby node in the computing nodes of the database system. In this embodiment, to implement disaster recovery processing on a cloud disk-based database, the heartbeat file is set in the cloud disk. The heartbeat file may be used to perform heartbeat detection on the primary node, to determine whether the primary node has an abnormality. Specifically, the heartbeat file may include lease information. The primary node may maintain the primary node state by updating the lease information in the heartbeat file. The primary node may periodically update the lease information in the heartbeat file according to a set lease renewal cycle.

As shown in step 601 in FIG. 6, the standby node may detect the validity of the lease information in the heartbeat file. In some embodiments, the lease information may be timestamp information. The timestamp information is a moment corresponding to expiration of a lease. Correspondingly, the lease information in the heartbeat file may be periodically read according to a set data reading cycle; and it is determined that the lease information in the heartbeat file is invalid if a timestamp of the lease information is earlier than a current time. The data reading cycle is shorter than the validity duration of the lease information in the heartbeat file.

The cloud disk supports a corresponding storage protocol standard. Usually, there are different role types in the storage protocol. Different roles have different access permissions on the cloud disk. Roles in the storage protocol usually include different roles such as a holder, a registrant, and a non-registrant (visitor). The holder has all operation permissions on the cloud disk, the registrant has partial operation permissions on the cloud disk, and the visitor has only a read permission on the cloud disk.

Because the cloud disk is in the target mode, the holder in the storage protocol has a read-write permission on the cloud disk, which is the same as a function of the primary node. The registrant has a read-only permission, which is the same as a function of the standby node Therefore, the cloud disk may be configured in the target mode. During startup, the computing node may determine a node state of the computing node. In this embodiment of the present application, a specific implementation of the computing node determining the node state of the computing node is not limited.

In some embodiments, whether the heartbeat file exists in the cloud disk may be detected. If the heartbeat file does not exist in the cloud disk, it indicates that the database system is a new instance, and there is no primary node, and it is determined that the node state of the computing node is the primary node. If the heartbeat file exists in the cloud disk, and an identifier of the cloud disk recorded in the heartbeat file is different from an identifier of a cloud disk maintained by the computing node, it indicates that the database system is an instance of cloud disk recovery, that is, the cloud disk attached to the computing node 10 is a new cloud disk snapshot, and it may be determined that the node state of the computing node is the primary node. That is, it is determined that the computing node is the primary node if the heartbeat file does not exist in the cloud disk or the identifier of the cloud disk recorded in the heartbeat file is different from the identifier of the cloud disk maintained by the computing node.

In some embodiments, if the heartbeat file exists in the cloud disk, and identification information of the cloud disk recorded in the heartbeat file is the same as the identifier of the cloud disk maintained by the computing node, it is determined that the state of the computing node is the standby node.

In some other embodiments, it is determined that the node state of the computing node is the standby node if the heartbeat file exists in the cloud disk, the identification information of the cloud disk recorded in the heartbeat file is the same as the identifier of the cloud disk maintained by the computing node, and the computing node is not a successor node. The successor node refers to a standby node that is designated by the primary node to take over the primary node's write access to the cloud disk when the primary node is abnormal. For the successor node, detailed descriptions are provided in the following embodiment, and details are not described here.

Further, it is determined that the node state of the computing node is the primary node if the heartbeat file exists in the cloud disk, the identification information of the cloud disk recorded in the heartbeat file is the same as the identifier of the cloud disk maintained by the computing node, the computing node is the successor node, and the lease information recorded in the heartbeat file is invalid.

Correspondingly, it is determined that the node state of the computing node is the standby node if the heartbeat file exists in the cloud disk, the identification information of the cloud disk recorded in the heartbeat file is the same as the identifier of the cloud disk maintained by the computing node, the computing node is the successor node, and the lease information recorded in the heartbeat file is within a validity period.

A manner of determining the node state of the computing node shown in the foregoing embodiment is merely exemplary descriptions, but does not constitute a limitation. Further, if the node state of the computing node is the primary node, it is determined that the primary node is a holder in the storage protocol, and the computing node may be registered as the holder in the storage protocol. If the node state of the computing node is the standby node, the standby node is a registrant in the storage protocol, and the computing node may be registered as the registrant in the storage protocol. In this way, the computing node may perform, based on the storage protocol supported by the cloud disk, disaster recovery processing on a cloud disk-based database. This part of content is described in the following embodiments, and details are not described here.

The computing node serving as the primary node may preempt a write permission of the cloud disk based on the storage protocol supported by the cloud disk, to register the primary node as the holder in the storage protocol. Specifically, for an embodiment in which the storage protocol is an NVMe protocol, the primary node may invoke a priority preempt (Preempt Action) interface provided by a PR protocol in the NVMe protocol, and obtain the write permission of the cloud disk via the priority preempt interface, to register the primary node as the holder in the PR protocol.

Optionally, a register interface of the PR protocol may be invoked to register the computing node as the registrant in the PR protocol. Further, the computing node may determine a node state of the computing node. For the specific implementation of determining the node state of the computing node, reference can be made to the related content of the foregoing embodiments, and details are not described here.

Further, if the node state of the computing node is the primary node, it is determined that the computing node is the holder in the storage protocol. Correspondingly, the computing node may invoke the priority preempt interface provided by the PR protocol in the NVMe protocol, and preempt the write permission of the cloud disk via the priority preempt interface, to modify a role type of the computing node from the registrant to the holder.

The primary node in the database system may maintain the primary node state by updating the lease information in the heartbeat file. That is, the primary node implements renewal of the primary node state by updating the lease information of the heartbeat file. The standby node may detect validity of the lease information in the heartbeat file.

In step 602, the standby node preempts the write permission of the cloud disk based on the storage protocol in a case of detecting that the lease information recorded in the heartbeat file is invalid, to register the standby node as a new holder. For a specific implementation of the successor node preempting the write permission of the cloud disk based on the storage protocol, reference can be made to the related content of preempting, by the primary node, the write permission of the cloud disk based on the storage protocol, and details are not described here again. Further, in step 603, the standby node may switch a node state of the standby node to the primary node state. That is, the standby node becomes a new primary node, and is responsible for reading and writing the cloud disk. Other standby nodes continue to remain as registrants in the storage protocol, and have the read-only permissions on the cloud disk.

The new primary node may update the information recorded in the heartbeat file. For example, the new primary node may update the lease information in the heartbeat file, and update address information of the holder that is recorded in the heartbeat file to address information of the new primary node.

In this embodiment, the primary node and the standby node are respectively registered as the holder and the registrant in the storage protocol. In this way, when the lease of the primary node is invalid, the standby node may preempt a write permission of a cloud disk based on the storage protocol supported by the cloud disk, and switch to be the primary node, thereby implementing disaster recovery processing of the database based on support of the cloud disk. Because the storage protocol is the standard protocol supported by the cloud disk, the disaster recovery manner of the database provided in this embodiment, based on the standard storage protocol supported by the cloud disk, implements disaster recovery processing on the database, eliminates the need to additionally develop or customize a disaster recovery solution of another protocol for the cloud disk-based database, and can improve universality of the disaster recovery processing solution of the cloud disk-based database.

In addition, because the standby node preempts the write permission on the cloud disk when the lease of the primary node is invalid, and is registered as the new holder, the original primary node loses the write permission of the cloud disk. Even if the original primary node is restarted, the original primary node cannot write data into the cloud disk because the write permission of the cloud disk is lost. Therefore, IO fencing against the original primary node is achieved, and a probability of database split-brain may be reduced.

In this embodiment of the present application, to reduce a probability of generating a ping-pong livelock when the standby nodes perform leader election concurrently when the primary node is abnormal, the computing device serving as the primary node may determine a successor node from the standby nodes registered as registrants in the storage protocol.

In this embodiment of the present application, a specific implementation of the primary node determining the successor node from the standby nodes is not limited. In some embodiments, the primary node may randomly select one standby node from the plurality of standby nodes as the successor node.

In some other embodiments, one standby node may be selected from the plurality of standby nodes as the successor node based on a priority mechanism. Specifically, the primary node may obtain priorities of the plurality of standby nodes; and select, according to the priorities of the plurality of standby nodes, a standby node having a highest priority as the successor node.

Optionally, performance parameter information of the plurality of standby nodes may be obtained; and the priorities of the plurality of standby nodes may be determined according to the performance parameter information of the plurality of standby nodes. A standby node having performance parameter information reflecting better performance has a higher priority.

Alternatively, in some other embodiments, the computing node may provide a priority setting interface. A user may specify priorities of the plurality of standby nodes via the priority setting interface. The computing node serving as the primary node may obtain the priorities of the plurality of standby nodes which are specified via the priority setting interface.

Further, after obtaining the priorities of the plurality of standby nodes, the primary node may select, according to the priorities of the plurality of standby nodes, a standby node having a highest priority as the successor node.

The method of determining the successor node shown in the foregoing embodiments is merely exemplary descriptions, and does not constitute a limitation. The primary node may further write an identifier of the successor node into the heartbeat file.

The computing node serving as the standby node may detect validity of the lease information recorded in the heartbeat file in the cloud disk; and enter a leader election procedure in the case of detecting that the lease information recorded in the heartbeat file is invalid. Specifically, the identifier of the successor node may be obtained from the heartbeat file. If the identifier of the successor node recorded in the heartbeat file is the standby node's own identifier, the standby node determines that the standby node itself is the successor node specified by the primary node. If the identifier of the successor node recorded in the heartbeat file is not the standby node's own identifier, it is determined that the standby node itself is not the successor node, and the leader election operation is not performed.

The foregoing unique successor node mechanism can ensure that only the successor node designated by the primary node can become a new primary node, which can effectively avoid leader election being performed by the plurality of standby nodes concurrently when the primary node is abnormal, and thereby reduce the probability of generating a Ping-Pong livelock.

The successor node may preempt the write permission of the cloud disk based on the storage protocol in the case of detecting that the lease information recorded in the heartbeat file is invalid, to register the successor node as the new holder. Further, the successor node may switch the node state of the successor node to the primary node state. That is, the successor node becomes a new primary node, and is responsible for reading and writing the cloud disk. Other standby nodes continue to remain as registrants in the storage protocol, and have the read-only permissions on the cloud disk. In this way, only the successor node performs leader election, which can effectively avoid leader election being performed by the plurality of standby nodes concurrently when the primary node is abnormal, and thereby reduce the probability of generating a Ping-Pong livelock.

In this embodiment of the present application, after preempting the write permission of the cloud disk, the successor node updates the information recorded in the heartbeat file. For example, the successor node may update the lease information recorded in the heartbeat file, update the address information of the holder that is recorded in the heartbeat file to address information of the successor node, and certainly, may also update term information (epoch) and the like in the heartbeat file. Other standby nodes may obtain the address information of the new holder from the heartbeat file, and update the maintained address information of the holder to the address information of the new holder (namely, the successor node).

The term information (epoch) may be an increasing field, that is, each time the term information is updated, a corresponding value increases by a set gradient. For example, for each update, the term information increases by 1 and so on. In some embodiments, a Generation field in the storage protocol may be used as the term information.

The computing device serving as the successor node may further modify the address information of the holder recorded in the heartbeat file into the address information of the successor node. The computing device serving as the standby node may monitor the term information in the heartbeat file; and obtain first address information of the holder from the heartbeat file in a case of detecting that the term information recorded in the heartbeat file changes. If first address information of the holder that is recorded in the heartbeat file is different from second address information of the holder that is maintained by the standby node, the standby node establishes, based on the first address information of the holder that is recorded in the heartbeat file, a connection to the primary node corresponding to the first address information. If the first address information of the holder that is recorded in the heartbeat file is the same as the second address information of the holder that is maintained by the standby node, it indicates that the term information changes due to other cases, and the standby node continues to maintain a connection to the primary node corresponding to the second address information.

During actual application, after recovering from an abnormality, the original primary node may be shut down or restarted. Some expected restarts of the primary node do not require triggering disaster recovery switching, which can maintain the stability of computing node roles. For a set shutdown instruction (such as a Shutdown instruction), the original primary node may modify the identifier of the successor node in the heartbeat file into the identifier of the original primary node in response to the set shutdown instruction. In this way, in a subsequent restart process of the original primary node in response to the shutdown instruction, even if the lease information recorded in the heartbeat file expires, the original primary node can continue to maintain the primary node state, thereby helping keep role stability of the computing node.

In some other embodiments, there may be a case where the successor node is not available. Because atomicity of three operations of the leader election operation cannot be guaranteed, where the three operations include (a) determining that the lease information recorded in the heartbeat file is invalid; (b) updating the lease information in the heartbeat file; and (c) performing a preempt priority operation to the write permission of the cloud disk, etc., the unique successor mechanism is used in some of the foregoing embodiments to avoid concurrent leader election.

However, this implementation has the following defect: if the successor node recorded in the heartbeat file is unavailable, and the original primary node fails to find that the successor node is unavailable in advance, there will be no computing node performing leader election, rendering the cloud disk permanently unavailable. Based on this, a successor node invalidity mechanism is introduced. Specifically, the computing node serving as the standby node may sleep for a random duration in the case of detecting that the lease information recorded in the heartbeat file is invalid and that the successor node is abnormal; and preempt, after sleeping for the random duration, the write permission of the cloud disk based on the storage protocol.

Specifically, the computing node serving as the standby node may monitor, in the case of detecting that the lease information in the heartbeat file is invalid, whether the lease information in the heartbeat file is updated; and if the lease information in the heartbeat file remains un-updated beyond a set duration, determine that the successor node is abnormal. The duration in which the lease information in the heartbeat file is un-updated may be timed from when the standby node detects that the lease information in the heartbeat file is invalid. The set duration may be flexibly set according to an actual efficiency requirement of disaster recovery.

In the foregoing embodiment, the duration in which the standby node sleeps is random, and may be timed from when it is determined that the successor node is abnormal. Because the durations in which respective standby nodes sleep are random, randomness is introduced. In a process in which each standby node randomly sleeps, there may be two standby nodes whose random durations of sleep have a difference value exceeding a total execution duration of the foregoing three operations (a), (b), and (c). In this case, one of the standby nodes will succeed in leader election. In this embodiment, for a scenario in which there is no primary node for a set duration, the database system is finally available at the cost of time and a small probability of Ping Pong, thereby helping improve robustness of the database.

In the foregoing embodiments, the database disaster recovery manner provided in the embodiments of the present application are illustratively described only with the case of a plurality of computing nodes. Certainly, the database disaster recovery manner provided in the embodiments of the present application may also be compatible with a database system without a standby node. In such a database system, the primary node may use the primary node itself as the successor node, and write the primary node's own identifier into the successor node field in the heartbeat file. In this way, in a restart process, the primary node detects that the successor node recorded in the heartbeat file is the primary node itself, and then, can preempt the write permission of the cloud disk again based on the storage protocol and become the holder.

During actual application, the standby node may also encounter an abnormality, stop running, or other cases, resulting in disconnection of a connection link with the primary node. In a case of detecting that the standby node exits from the registrant, the primary node may delete relevant information of the standby node and the like when selecting the successor node.

It should be noted that, steps of the method provided in the foregoing embodiments may be performed by a same device, or the method may be performed by different devices. For example, step 601 and step 602 may be performed by a device A. For another example, step 601 may be performed by the device A, and step 602 may be performed by a device B.

In addition, some procedures described in the foregoing embodiments and accompanying drawings include a plurality of operations appearing in a particular order. However, it should be clearly learned that these operations may not be performed in the order in which these operations appear in the specification or may be performed in parallel. Sequence numbers, such as 601 and 602, of the operations are merely used to distinguish different operations, and the sequence numbers do not represent any execution order. In addition, these procedures may include more or fewer operations, and these operations may be performed in an order or in parallel.

Correspondingly, an embodiment of the present application further provides a computer-readable storage medium storing computer instructions, where the computer instructions, when executed by one or more processors, cause the one or more processors to perform the steps in the foregoing database disaster recovery method.

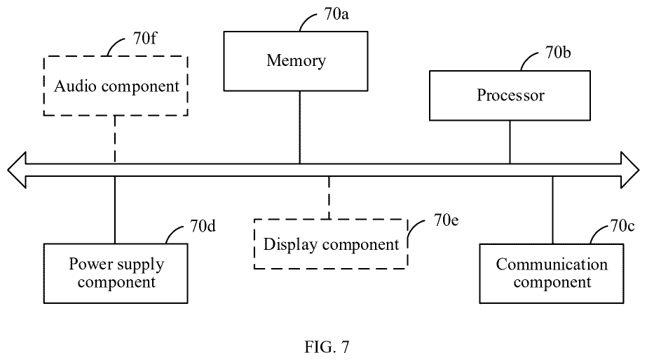

FIG. 7 is a schematic structural diagram of a computing device according to an embodiment of the present application. In this embodiment, the computing device may be implemented as a computing node in a database system; the database system further includes a cloud disk configured in a target mode; a holder in a storage protocol supported by the cloud disk has a read-write permission on the cloud disk in the target mode; and a registrant in the storage protocol has a read-only permission on the cloud disk in the target mode. The computing device may be implemented as a standby node of the database system, or may be implemented as a primary node of the database system. Generally, the computing device may be a primary node at a moment, and may also be demoted to a standby node at another moment. The computing device may be registered as the holder in the storage protocol when being the primary node. The computing device may be registered as the registrant in the storage protocol when being the standby node.

As shown in FIG. 7, the computing device includes a memory 70a and a processor 70b. The memory is configured to store a computer program; and the processor 70b is coupled to the memory 70a, and is configured to execute the computer program to implement the steps in the database disaster recovery method provided in the foregoing embodiments.

Specifically, when the computing device is implemented as the standby node, the processor 70b may be configured to: detect validity of lease information in a heartbeat file stored in the cloud disk, where the primary node maintains a primary node state by modifying the lease information; preempt a write permission of the cloud disk based on the storage protocol in a case of detecting that the lease information is invalid, to register the standby node as a new holder; and switch a node state of the computing device to the primary node state.

Optionally, when detecting the validity of the lease information in the heartbeat file, the processor 70b is specifically configured to:
periodically read, according to a set data reading cycle, the lease information recorded in the heartbeat file; and
determine that the lease information in the heartbeat file is invalid if a timestamp of the lease information recorded in the heartbeat file is earlier than a current time, where the data reading cycle is shorter than a validity duration of the lease information in the heartbeat file.

In some embodiments, the storage protocol is an NVMe protocol, and the NVMe protocol includes a PR protocol. When preempting the write permission of the cloud disk based on the storage protocol, the processor 70b is specifically configured to: invoke a priority preempt interface provided by the PR protocol; and preempt the write permission of the cloud disk via the priority preempt interface, to register the computing device as a holder in the PR protocol.

When the computing device is implemented as the primary node, the processor 70b is further configured to: preempt the write permission of the cloud disk based on the storage protocol before the standby node detects the validity of the lease information in the heartbeat file stored in the cloud disk, to register the primary node as the holder in the storage protocol; and maintain the primary node state by updating the lease information in the heartbeat file.

Optionally, the storage protocol is an NVMe protocol, and the NVMe protocol includes a PR protocol. The processor 70b is further configured to: before the primary node preempts the write permission of the cloud disk based on the storage protocol, invoke a registration interface of the PR protocol, to register the computing node as a registrant in the PR protocol; determine a node state of the computing node; and perform, if the node state of the computing device is the primary node, the step of preempting, by the primary node, the write permission of the cloud disk based on the storage protocol, to register the primary node as the holder in the storage protocol.

In some embodiments, there are a plurality of standby nodes. When the computing device is implemented as the primary node, the processor 70b is further configured to: determine, by the primary node, a successor node from the plurality of standby nodes; and write an identifier of the successor node into the heartbeat file. Correspondingly, when the computing device is implemented as the standby node, the processor 70b may determine, in a case of detecting that the lease information recorded in the heartbeat file is invalid, whether the identifier of the successor node recorded in the heartbeat file is an identifier of the standby node; and if yes, perform the step of preempting the write permission of the cloud disk based on the storage protocol, to register the standby node as the new holder.

Optionally, when determining the node state of the computing node, the processor 70b is specifically configured to: determine that the node state of the computing node is the primary node if the heartbeat file does not exist in the cloud disk or an identifier of a cloud disk recorded in the heartbeat file is different from an identifier of a cloud disk maintained by the computing node; determine that the node state of the computing node is the standby node if the heartbeat file exists in the cloud disk, the identifier of the cloud disk recorded in the heartbeat file is the same as the identifier of the cloud disk maintained by the computing node, and the computing node is not the successor node; determine that the node state of the computing node is the primary node if the heartbeat file exists in the cloud disk, the identifier of the cloud disk recorded in the heartbeat file is the same as the identifier of the cloud disk maintained by the computing node, the computing node is the successor node, and the lease information in the heartbeat file is invalid; and determine that the node state of the computing node is the standby node if the heartbeat file exists in the cloud disk, the identifier of the cloud disk recorded in the heartbeat file is the same as the identifier of the cloud disk maintained by the computing node, the computing node is the successor node, and the lease information in the heartbeat file is within a validity period.

Optionally, when determining the successor node from the plurality of standby nodes, the processor 70b is specifically configured to: randomly select one standby node from the plurality of standby nodes as the successor node; or obtain priorities of the plurality of standby nodes; and select, according to the priorities of the plurality of standby nodes, a standby node having a highest priority as the successor node.

Further, when obtaining the priorities of the plurality of standby nodes, the processor 70b is specifically configured to: obtain performance parameter information of the plurality of standby nodes; and determine the priorities of the plurality of standby nodes according to the performance parameter information of the plurality of standby nodes, where a standby node having performance parameter information reflecting better performance has a higher priority; or obtain the priorities of the plurality of standby nodes that are specified via a priority setting interface.

In some embodiments, the heartbeat file includes term information and address information of the holder. If the computing device is the successor node, the processor 70b is further configured to: update, after preempting the write permission of the cloud disk, the term information recorded in the heartbeat file; and change the address information of the holder into address information of the successor node.

For the computing device serving as the standby node, the processor 70b is further configured to monitor the term information in the heartbeat file; obtain first address information of the holder from the heartbeat file in a case of detecting that the term information in the heartbeat file changes; and establish, based on the first address information in a case that the first address information is different from second address information of a holder maintained by the standby node, a connection to a primary node corresponding to the first address information.

For the computing device serving as the primary node, the processor 70b is further configured to: modify, in response to a set shutdown instruction, the identifier of the successor node recorded in the heartbeat file into an identifier of the primary node, to cause the primary node to maintain the primary node state in a process of restarting in response to the shutdown instruction.

For the computing device serving as the standby node, the processor 70b is further configured to: sleep, for a random duration in a case of detecting that the lease information recorded in the heartbeat file is invalid and that the successor node is abnormal; and preempt, after sleeping for the random duration, the write permission of the cloud disk based on the storage protocol.

Optionally, the processor 70b is further configured to monitor, in the case of detecting that the lease information in the heartbeat file is invalid, whether the lease information in the heartbeat file is updated; and determine that the successor node is abnormal if the lease information in the heartbeat file remains un-updated beyond a set duration.

In some optional implementations, as shown in FIG. 7, the computing device may further include optional components such as a communication component 70c and a power supply component 70d. In some embodiments, the computing device may be implemented as a terminal device such as a computer, and may further include components such as a display component 70e and an audio component 70f. Only some components are schematically shown in FIG. 7, which does not mean that the computing device necessarily includes all the components shown in FIG. 7, nor does it mean that the computing device can only include the components shown in FIG. 7.

In the embodiments, the primary node and the standby node are respectively registered as the holder and the registrant in the storage protocol. In this way, when the primary node is abnormal, the standby node may preempt a write permission of a cloud disk based on the storage protocol supported by the cloud disk, and switch to be the primary node, thereby implementing disaster recovery processing of the database based on support of the cloud disk. Because the storage protocol is the standard protocol supported by the cloud disk, the disaster recovery manner of the database provided in the embodiment, based on the standard storage protocol supported by the cloud disk, not only can implement disaster recovery processing of the database and ensure high availability of the cloud disk-based database, but also eliminates the need to additionally develop or customize a disaster recovery solution of another protocol for the cloud disk-based database and can improve universality of the disaster recovery processing solution of the cloud disk-based database.

In the embodiments of the present application, the memory is configured to store a computer program, and can be configured to store various other data to support operations on the device on which the computer program is located. The processor can execute the computer program stored in the memory, to implement a corresponding control logic. The memory may be implemented by using a volatile or non-volatile storage device of any type or a combination thereof, for example, a static random-access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disc.

In the embodiments of the present application, the processor may be a hardware processing device that can perform the foregoing method logic. Optionally, the processor may be a central processing unit (CPU), a graphics processing unit (GPU), or a microcontroller unit (MCU); or may be a programmable device such as a field-programmable gate array (FPGA), a programmable array logic (PAL) device, a general array logic (GAL) device, or a complex programmable logic (CPLD) device; or an advanced reduced instruction set computer (RISC) processor (Advanced RISC Machine, ARM), a system-on-chip (SoC), or the like, but is not limited thereto.

In embodiments of the present application, the communication component is configured to facilitate wired or wireless communication between a device in which the communication component is located and another device. The device in which the communication component is located may access a wireless network based on a communication standard, such as wireless fidelity (Wi-Fi), 2G or 3G, 4G, 5G, or a combination thereof. In an exemplary embodiment, the communication component receives a broadcast signal or broadcast related information from an external broadcast management system through a broadcast channel. In an exemplary embodiment, the communication component may be further implemented based on a near field communication (NFC) technology, a radio frequency identification (RFID) technology, an infrared data association (IrDA) technology, an ultra wide band (UWB) technology, a Bluetooth (Bluetooth, BT) technology, or another technology.

In embodiments of the present application, the display component may include a liquid crystal display (LCD) and a touch panel (TP). If the display component includes the touch panel, the display component may be implemented as a touchscreen, to receive an input signal from a user. The touch panel includes one or more touch sensors to sense a touch, a swipe, and a gesture on the touch panel. The touch sensor may not only sense a boundary of the touch or swiping operation, but also detect duration and pressure that are related to the touch or swiping operation.

In embodiments of the present application, the power supply component is configured to supply power to various components of a device in which the power supply component is located. The power supply component may include a power supply management system, one or more power supplies, and other components associated with generating, managing, and allocating power for the device in which the power supply component is located.

In embodiments of the present application, the audio component may be configured to output and/or input an audio signal. For example, the audio component includes a microphone (MIC). When a device in which the audio component is located is in an operation mode, such as a calling mode, a recording mode, and a voice identification mode, the microphone is configured to receive an external audio signal. The received audio signal may be further stored in a memory or sent through the communication component. In some embodiments, the audio component further includes a speaker configured to output an audio signal. For example, for a device having a language interaction function, voice interaction with the user may be implemented through the audio component.

It should be noted that, descriptions of “first”, “second”, and the like in the specification are used to distinguish different messages, devices, modules, and the like, and do not indicate an order and do not limit that “first” and “second” are different types either.

A person skilled in the art is to understand that embodiments of the present application may be provided as a method, a system, or a computer program product. Therefore, the present application may take the form of hardware-only embodiments, software-only embodiments, or embodiments with a combination of software and hardware. In addition, the present application may use a form of a computer program product that is implemented on one or more computer-usable storage media (including but not limited to a magnetic disk memory, a compact disc read-only memory (CD-ROM), an optical memory, and the like) that include computer-usable program code.

The present application is described with reference to the flowcharts and/or block diagrams of the method, the device (system), and the computer program product according to the embodiments of the present application. It should be understood that computer program instructions can implement each procedure and/or block in the flowcharts and/or block diagrams and a combination of procedures and/or blocks in the flowcharts and/or block diagrams. These computer program instructions may be provided for a general-purpose computer, a dedicated computer, an embedded processor, or a processor of another programmable data processing device to generate a machine, so that an apparatus configured to implement functions specified in one or more processes in the flowcharts and/or one or more blocks in the block diagrams is generated by using instructions executed by the computer or the processor of another programmable data processing device.

These computer program instructions may be stored in a computer-readable memory that can instruct the computer or any other programmable data processing device to work in a specific manner, so that the instructions stored in the computer-readable memory generate an artifact that includes an instruction apparatus. The instruction apparatus implements a specific function in one or more processes in the flowcharts and/or in one or more blocks in the block diagrams.

The computer program instructions may alternatively be loaded onto a computer or another programmable data processing device, so that a series of operation steps are performed on the computer or the another programmable device to generate computer-implemented processing. Therefore, the instructions executed on the computer or the another programmable device provide steps for implementing a specific function in one or more processes in the flowcharts and/or in one or more blocks in the block diagrams.

In a typical configuration, a computing device includes one or more processors (CPU and the like), an input/output interface, a network interface, and a memory.

The memory may include a volatile memory in a computer-readable medium, a random-access memory (RAM), and/or a non-volatile memory, such as a read-only memory (ROM) or a flash RAM (flash RAM). The memory is an example of a computer-readable medium.

A storage medium of the computer is a readable storage medium, and may also be referred to as a readable medium. The readable storage medium includes a non-volatile medium and a volatile medium, a removable medium and a non-removable medium, which may implement storage of information by using any method or technology. The information may be computer-readable instructions, a data structure, a program module, or other data. An example of computer storage media includes, but is not limited to, a phase-change memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, disk storage or another magnetic storage device or any other non-transmission medium that may be configured to store information that a computing device can access. According to limitations of this specification, the computer-readable medium does not include transitory media, such as a modulated data signal and a modulated carrier.

It should be further noted that the terms “include”, “comprise”, or any variants thereof are intended to cover a non-exclusive inclusion. Therefore, a process, method, article, or device that includes a series of elements not only includes such elements, but also includes other elements not specified expressly, or may include inherent elements of the process, method, article, or device. Unless otherwise specified, an element limited by “including a/an” does not exclude other same elements existing in the process, the method, the article, or the device that includes the element.

The foregoing content is merely embodiments of the present application and are not intended to limit the present application. For a person skilled in the art, various modifications and variations can be made to the present application. Any modification, equivalent replacement, or improvement made without departing from the spirit and principle of the present application shall fall within the scope of the claims of the present application.

1. A database disaster recovery method, wherein a database system comprises: computing nodes and a cloud disk configured in a target mode;
wherein a holder in a storage protocol supported by the cloud disk has a read-write permission on the cloud disk in the target mode;
wherein a registrant in the storage protocol has a read-only permission on the cloud disk in the target mode;
wherein the computing nodes comprise a primary node registered as the holder and a standby node registered as the registrant, and the method comprises:
detecting, by the standby node, validity of lease information in a heartbeat file stored in the cloud disk, wherein the primary node maintains a primary node state by modifying the lease information;
in response to detecting that the lease information is invalid, preempting, by the standby node, a write permission of the cloud disk based on the storage protocol, to register the standby node as a new holder; and
switching a node state of the standby node to the primary node state.

2. The method according to claim 1, wherein the storage protocol is a non-volatile memory host controller interface specification (NVMe) protocol, and the NVMe protocol comprises a persistent reservation PR protocol; and the preempting, by the standby node, the write permission of the cloud disk based on the storage protocol, to register the standby node as the new holder comprises:
invoking, by the standby node, a priority preempt interface provided by the PR protocol; and
preempting the write permission of the cloud disk via the priority preempt interface, to register the standby node as a holder in the PR protocol.

3. The method according to claim 1, wherein before the detecting, by the standby node, the validity of the lease information in the heartbeat file stored in the cloud disk, the method further comprises:
preempting, by the primary node, the write permission of the cloud disk based on the storage protocol, to register the primary node as the holder in the storage protocol; and
maintaining the primary node state by updating the lease information in the heartbeat file.

4. The method according to claim 3, wherein the storage protocol is an NVMe protocol, and the NVMe protocol comprises a PR protocol; and before the preempting, by the primary node, the write permission of the cloud disk based on the storage protocol, the method further comprises:
invoking, by a computing node, a registration interface of the PR protocol, and registering the computing node as a registrant in the PR protocol; and
determining a node state of the computing node; and performing, in response to determining that the node state of the computing node is the primary node, the step of preempting, by the primary node, the write permission of the cloud disk based on the storage protocol, to register the primary node as the holder in the storage protocol.

5. The method according to claim 4, wherein a quantity of standby nodes is more than one; and the method further comprises:
determining, by the primary node, a successor node from a plurality of standby nodes;
writing an identifier of the successor node into the heartbeat file;
determining, by the standby node in response to detecting that the lease information recorded in the heartbeat file is invalid, whether the identifier of the successor node recorded in the heartbeat file is an identifier of the standby node; and
in response to determining that the identifier of the successor node recorded in the heartbeat file is the identifier of the standby node, performing the step of preempting, by the standby node, the write permission of the cloud disk based on the storage protocol, to register the standby node as the new holder.

6. The method according to claim 5, wherein the determining the node state of the computing node comprises:
determining that the node state of the computing node is the primary node in response to determining that the heartbeat file does not exist in the cloud disk or an identifier of a cloud disk recorded in the heartbeat file is different from an identifier of a cloud disk maintained by the computing node;
determining that the node state of the computing node is the standby node in response to determining that the heartbeat file exists in the cloud disk, the identifier of the cloud disk recorded in the heartbeat file is the same as the identifier of the cloud disk maintained by the computing node, and the computing node is not the successor node;
determining that the node state of the computing node is the primary node in response to determining that the heartbeat file exists in the cloud disk, the identifier of the cloud disk recorded in the heartbeat file is the same as the identifier of the cloud disk maintained by the computing node, the computing node is the successor node, and the lease information in the heartbeat file is invalid;
determining that the node state of the computing node is the standby node in response to determining that the heartbeat file exists in the cloud disk, the identifier of the cloud disk recorded in the heartbeat file is the same as the identifier of the cloud disk maintained by the computing node, the computing node is the successor node, and the lease information in the heartbeat file is within a validity period.

7. The method according to claim 5, wherein the determining, by the primary node, the successor node from the plurality of standby nodes comprises:
randomly selecting a standby node from the plurality of standby nodes as the successor node;
or
obtaining priorities of the plurality of standby nodes; and selecting, according to the priorities of the plurality of standby nodes, a standby node having a highest priority as the successor node.

8. The method according to claim 7, wherein the obtaining the priorities of the plurality of standby nodes comprises:
obtaining performance parameter information of the plurality of standby nodes; and determining the priorities of the plurality of standby nodes according to the performance parameter information of the plurality of standby nodes, wherein a standby node having the performance parameter information reflecting better performance has a higher priority;
or
obtaining the priorities of the plurality of standby nodes that are specified via a priority setting interface.

9. The method according to claim 5, wherein the heartbeat file comprises term information and address information of the holder; and the method further comprises:
updating, by the successor node after preempting the write permission of the cloud disk, the term information recorded in the heartbeat file; and changing the address information of the holder into address information of the successor node; and
monitoring, by the standby node, the term information in the heartbeat file; obtaining first address information of the holder from the heartbeat file in response to detecting that the term information in the heartbeat file changes; and establishing, based on the first address information in response to determining that the first address information is different from second address information of a holder maintained by the standby node, a connection to a primary node corresponding to the first address information.

10. The method according to claim 5, further comprising:
modifying, by the primary node in response to a set shutdown instruction, the identifier of the successor node recorded in the heartbeat file into an identifier of the primary node, to cause the primary node to maintain the primary node state in a process of restarting in response to the shutdown instruction.

11. The method according to claim 5, further comprising:
sleeping, by the standby node, for a random duration in response to detecting that the lease information recorded in the heartbeat file is invalid, and that the successor node is abnormal; and preempting, after sleeping for the random duration, the write permission of the cloud disk based on the storage protocol.

12. The method according to claim 11, further comprising:
monitoring, by the standby node in response to detecting that the lease information in the heartbeat file is invalid, whether the lease information in the heartbeat file is updated; and
determining that the successor node is abnormal in response to determining that the lease information in the heartbeat file remains un-updated beyond a set duration.

13. The method according to claim 1, wherein the detecting, by the standby node, the validity of the lease information in the heartbeat file comprises:
periodically reading, by the standby node according to a set data reading cycle, the lease information recorded in the heartbeat file; and
determining that the lease information in the heartbeat file is invalid in response to determining that a timestamp of the lease information recorded in the heartbeat file is earlier than a current time, wherein the data reading cycle is shorter than a validity duration of the lease information in the heartbeat file.

14. A database system, comprising a plurality of computing nodes and a cloud disk;
wherein the plurality of computing nodes share the cloud disk, and the cloud disk is configured in a target mode and stores a heartbeat file;
wherein a holder in a storage protocol has a read-write permission on the cloud disk in the target mode;
wherein a registrant in the storage protocol has a read-only permission on the cloud disk in the target mode; and
a computing device is configured to perform following steps:
detecting validity of lease information in a heartbeat file stored in the cloud disk, wherein a primary node in the database system maintains a primary node state by modifying the lease information;
in response to detecting that the lease information is invalid, preempting a write permission of the cloud disk based on the storage protocol, to register the computing device as a new holder; and
switching a node state of the computing device to the primary node state.

15. A computing device, wherein the computing device is implemented as a computing node in a database system;
wherein the database system further comprises a cloud disk configured in a target mode;
wherein a holder in a storage protocol supported by the cloud disk has a read-write permission on the cloud disk in the target mode;
wherein a registrant in the storage protocol has a read-only permission on the cloud disk in the target mode; and
the computing device comprises a memory and a processor, wherein the memory is configured to store a computer program; and the processor is coupled to the memory, and is configured to execute the computer program, to perform following steps:
detecting validity of lease information in a heartbeat file stored in the cloud disk, wherein a primary node in the database system maintains a primary node state by modifying the lease information;
in response to detecting that the lease information is invalid, preempting a write permission of the cloud disk based on the storage protocol, to register the computing device as a new holder; and
switching a node state of the computing device to the primary node state.

16. A computer-readable storage medium storing computer instructions, wherein the computer instructions, when executed by one or more processors, cause the one or more processors to perform the steps in the method according to any of claim 1.

17. The computing device according to claim 15, wherein the storage protocol is a non-volatile memory host controller interface specification (NVMe) protocol, and the NVMe protocol comprises a persistent reservation PR protocol; and the processor is specifically configured to execute the computer program, to perform following operations:
invoking a priority preempt interface provided by the PR protocol; and preempting the write permission of the cloud disk via the priority preempt interface, to register the computing device as a holder in the PR protocol.

18. The computing device according to claim 15, wherein there are a plurality of standby nodes; and the processor is specifically configured to execute the computer program, to perform following operations:
determining, in response to detecting that the lease information recorded in the heartbeat file is invalid, whether an identifier of a successor node recorded in the heartbeat file is an identifier of the computing device; wherein the successor node is determined by the primary node from the plurality of standby nodes;
in response to determining that the identifier of the successor node recorded in the heartbeat file is the identifier of the computing device, performing the step of preempting the write permission of the cloud disk based on the storage protocol, to register the computing device as the new holder.

19. The computing device according to claim 18, wherein
the successor node is randomly selected from the plurality of standby nodes; or
the successor node is selected according to priorities of the plurality of standby nodes;
wherein the priorities of the plurality of standby nodes are determined according to performance parameter information of the plurality of standby nodes, a standby node having the performance parameter information reflecting better performance has a higher priority, and a standby node having a highest priority is determined as the successor node.

20. The computing device according to claim 18, wherein the identifier of the successor node recorded in the heartbeat file is not the identifier of the computing device, and the processor is configured to execute the computer program, to perform following operations: sleeping for a random duration in response to detecting that the lease information recorded in the heartbeat file is invalid, and that the successor node is abnormal; and preempting, after sleeping for the random duration, the write permission of the cloud disk based on the storage protocol.
